(19) United States
(12) Patent Application Publication
(10) Pub. No.: US 2014/0311615 A1
(43) Pub. Date: Oct. 23, 2014

(54) Barrier Structure and Laminate Thereof

(71) Applicant: Mrinal Kanti Banerjee, Mumbai (IN)

(72) Inventor: Mrinal Kanti Banerjee, Mumbai (IN)

(73) Assignee: ESSEL PROPACK LIMITED, Mumbai (IN)

(21) Appl. No.: 14/123,019

(22) PCT Filed: May 31, 2012
(86) PCT No.: PCT/IN2012/000377

§ 371 Date: Jun. 19, 2014

(30) Foreign Application Priority Data
May 31, 2011 (IN) 1600/MUM/2011

(51) Int. Cl. F16L 9/147; B32B 15/085; B29D 23/20; B32B 15/20

(52) U.S. Cl. CPC F16L 9/147; B32B 15/20; B32B 15/085; B29D 23/20; B32B 2307/7265; B32B 2597/00
USPC 138/145; 428/461; 428/216; 264/138

(57) ABSTRACT

The present disclosure provides a barrier structure comprising: an outer polyethylene layer containing a pigment; a core aluminum layer between two acid copolymer layers; and an inner polyethylene layer; wherein the pigment is with a polyethylene resin in an amount in the range of 50% to 75% w/w ratio with the polyethylene carrier resin.

The present disclosure also provides a barrier structure, wherein said barrier structure is an internal barrier liner.

The present disclosure further provides a barrier structure wherein said barrier structure is a barrier laminate.

### TECHNICAL FIELD

The present disclosure relates to a barrier structure, an internal barrier liner comprising said barrier structure, a barrier laminate, and packaging products thereof. The barrier structure of the present disclosure is beneficial as inner barrier liner for tube shoulder or as laminated tube for packaging contents that are chemicals susceptible to oxidation or aggressive chemicals, such as hair colorants.

### BACKGROUND

Different types of barrier liners in shoulders and laminates with barrier layers are used for packaging of reactive or aggressive contents such as hair colorants or hair dyes. In general, laminated tubes are of different types such as, Aluminium Barrier Laminated (ABL) tubes and Plastic Barrier Laminated (PBL) tubes. Generally, ABL tubes are made from a plurality of polymer layers with Aluminium foil barrier placed between the polymer layers. However, the PBL tubes are made of the polymers, preferably high molecular mass polymers such as plastic, with the barrier layer made of a polymeric material such as, Ethyl Vinyl alcohol (EVOH).

In particular, the body of the laminated tube can be co-extruded into the multilayered structure to achieve the desired barrier properties. However, the shoulder of the tube cannot be compression molded into multilayered structure to achieve the desired barrier properties. The shoulder of the tube is compression molded using a single layer and then attached with the body of the tube. The shoulder is generally welded with the body of the tube by heat and pressure (generated by compression molding) technique.

Cosmetics, such as hair colors have ingredients which are chemically very reactive. The ingredients present in the hair color reacts with the material of the tube which damages the product stored. For example, ammonia present in the hair color reacts with the material of the tube, resulting in oozing out of the hair color stored in the tube and ingression of oxygen and moisture which destroys the hair color stored in the tube.

Typically, ABL tubes are used for storing hair colors. While EVOH barrier is a good oxygen barrier, it is susceptible to high humidity. EVOH having less chemical resistivity is not favorable for barriers for packing of contents with reactive chemicals. Aluminum barrier on the other hand reacts with chemicals, such as ammonia, contained in products such as hair colorant, and hence disadvantageous for such applications.

Aluminium tubes coated with lacquer such as epoxy lacquer are also used for such applications. However, the epoxy lacquer coating possesses pinholes or voids which on storage, reacts with the ammonia in the hair colorant formulation which creates cracks in the tube and the hair color oozes out of the tube.

Another disadvantage of the epoxy lacquer coated Aluminum tube is that it makes the transportation of the tubes difficult as the same is prone to dent and de-shaped during transit. Further, tubes for carrying hair colorants with polypropylene (PP) layers or PP copolymer layers have been used as barrier liners in shoulders. However, the use of PP in such shoulder or laminated tubes for hair colorant types of chemicals is not desirable because PP is less resistant to ammonia or other hair colorant pigments. Also, PP is more heat resistant and it needs higher temperature to bond with other polar and non-polar polymers. Hence processing with PP polymers or co-polymers of PP is difficult.

Hence, there is a need for a barrier liner for tube shoulder and a laminate for packaging that gives advantageous barrier properties for tube packaging in applications such as hair colorants.

### SUMMARY

The present disclosure relates to a barrier structure comprising: an outer polyethylene layer containing a pigment; a core Aluminum layer between two acid copolymer layers; and an inner polyethylene layer; wherein the pigment is with a polyethylene resin in an amount in the range of 50% to 75% w/w ratio with the polyethylene carrier resin.

These and other features, aspects, and advantages of the present subject matter will become better understood with reference to the following description. This summary is provided to introduce a selection of concepts in a simplified form. This summary is not intended to identify key features or essential features of the disclosure, nor is it intended to be used to limit the scope of the subject matter.

### DETAILED DESCRIPTION

The present disclosure provides a barrier structure comprising an outer polyethylene layer containing a pigment; a core Aluminum layer between two acid copolymer layers; and an inner polyethylene layer; wherein the pigment is with a polyethylene resin in an amount in the range of 50% to 75% w/w ratio with the polyethylene carrier resin.

In an embodiment of the present disclosure the outer and inner polyethylene layer in the barrier structure have density in the range of 0.94 g/cc to 0.96 g/cc. In another embodiment of the present disclosure the acid copolymer in the barrier structure is selected from ethylene acrylic acid copolymer (EAA), ethylene vinyl acetates, ethylene methacrylic acid copolymer, maleic anhydride copolymer, or mixtures thereof The acid copolymer in the barrier structure is preferably ethylene acrylic acid copolymer.

In yet another embodiment of the present disclosure the pigment in the outer polyethylene layer is a white pigment. Non-limitative examples of the white pigment in accordance with the present disclosure are titanium dioxide (TiO2), zinc disulfide (ZnS2), zinc oxide (ZnO) and barium sulfate (BaSO4). The shape of the pigment is not particularly limited; they may be notably granule, round, flaky, flat and so on. The white pigment is preferably titanium dioxide in master batch form. Titanium dioxide loading could be anything between 50% to 75% w/w ratio with Polyethylene carrier resin. The titanium dioxide used in the present disclosure are notably commercially available titanium dioxide.

In accordance with the present invention, the amount of the pigment between 50% to 75% w/w ratio with Polyethylene carrier resin in the outer polyethylene layer of the barrier structure is critical for the barrier laminate to show improved barrier properties. The presence of the pigments allows the properties of the hair colorants to be stored in the laminate tubes to be maintained for a long period of time. Further, the quality assurance period by a manufacturer is greatly extended without the release of components through the shoulder or cause of any change in the quality of the contents. Consequently, a laminate tube having the body and the shoulder according to the present disclosure is extremely useful to be used for products which are highly reactive.

Titanium dioxide is not particularly limited, and a variety of crystalline forms such as the anatase form, the rutile form and the monoclinic type can be used. The preferably average particle size of the titanium oxide is in the range of 0.15 μm to 0.35 μm)

In one embodiment, the inner polyethylene layer is a multi layer film.

The barrier structure of the present disclosure can be used as an internal barrier liner in shoulder of tubes and also as laminate for making tubes. This is because the barrier structure provides chemical as well as oxygen barrier that is resistant to humidity also, which is preferable for packing and shoulders for aggressive and reactive chemicals present in product formulations such as hair colorant. The thickness of the layers of the barrier structure can be modified to suit end applications. For instance, for using as inner barrier liner, the barrier structure will have the polymer layers with lesser thickness. In case of laminated tubes, the barrier structure has polymer layers with higher thickness.

In still another embodiment of the present disclosure the barrier structure is an internal barrier liner comprising an outer polyethylene layer having thickness in the range of 40 μ to 70 μ along with a pigment; a core aluminum layer having thickness in the range of 12 μ to 20 μ between two acid copolymers layers; and an inner polyethylene layer having thickness in the range of 40 μ to 70 μ; wherein each of the two acid copolymers have a thickness in the range of 20 μ to 30 μ and the pigment is with a polyethylene resin in an amount in the range of 50% w/w to 75% w/w ratio with the polyethylene carrier resin.

The polymer layer in the internal barrier liner is polyethylene polymer.

In a preferred embodiment, the core aluminum layer is of 20 μ, the polyethylene outer layer is 40 μ; and the polyethylene inner layer is 50 μ. The total thickness of the inner barrier liner is about 150 μ-170 μ, preferably 160 μ.

The outer polyethylene layer of the inner barrier liner, in one embodiment, comprises pigments, preferably white pigments.

The structure of the shoulder of a packaging tube for aggressive and reactive contents such as hair colorant requires good resistivity to the chemicals as well as to oxygen and moisture. Generally, the shoulder of the tube is made from polyethylene, such as high density polyethylene (HDPE). The HDPE provides high chemical resistivity but has poor permeability for oxygen, carbon dioxide and odorous/aromatizing substances. Therefore, the undesired substances diffuse or pass out of the tube into the environment or pass from the environment into the tube. The present disclosure is directed toward an inner barrier liner for using in tube shoulder that provides good barrier to both chemical and oxygen or humidity.

In still another embodiment of the present disclosure the inner barrier liner is used for manufacturing a tube shoulder, wherein said tube shoulder is made of high density polyethylene (HDPE).

In a further embodiment of the present disclosure the tube shoulder is made by a process comprising: punching a barrier laminate to the size and shape of the tube shoulder to be prepared to obtain a punched laminate; mounting the punched laminate to a mandrel tip where the tube body is already pre-loaded to obtain a mandrel mounted with tube body; moving the mandrel mounted with tube body and the barrier laminate to a next station where a doughnut shaped HDPE is dosed inside a shoulder mould; closing and compressing the shoulder mould and the mandrel, mounted with tube body and barrier laminate to form a desired shape of a shoulder; fixing the barrier laminate permanently to an inner dome surface of the compression molded tube shoulder; fusing the barrier laminate medium density polyethylene layer with the melted doughnut shaped HDPE, thereby forming a permanent bond together with the composite linear laminate to obtain the tube shoulder.

In still another embodiment of the present disclosure the barrier structure is a laminate comprising: an outer polyethylene layer having a thickness of 100 μ along with a pigment; a core aluminum layer having thickness in the range of 12 μ-20 μ between two acid copolymers; and an inner polyethylene layer having a thickness of 100 μ; wherein each of the two acid copolymer layers have thickness in the range of 20 μ-40 μ and the pigment is with a polyethylene resin in an amount in the range of 50% to 75% w/w ratio with the polyethylene carrier resin.

In yet another embodiment of the present disclosure the core aluminum layer has a thickness of 20 μ. The total thickness of the barrier laminate is in the range of 250 μ-300 μ, preferably 290 μ.

In one embodiment, the outer polyethylene layer comprises pigments, preferably white pigments. In this embodiment, the white pigment is preferably titanium oxide.

In another embodiment of the present disclosure the layers of the barrier laminate are multi-layered.

The barrier laminate of the present disclosure is advantageously applicable for tubes used for products such as hair colorants. In general, the laminated tubes, interchangeably referred to as tubes, are used for packaging in various sectors like oral care, food, cosmetics, pharmaceuticals, and also for other industrial applications. The laminate tubes can have three or more layers. The number of layers in the multilayered structure is chosen based on the product stored in the tube and the type of barrier properties required.

The barrier laminate of the present disclosure can be used in the body of the tube as well as the shoulder of the tube. However, it will be understood, that the barrier laminate used for the body possesses different properties such as thickness with respect to the properties of the barrier laminate used for the shoulder of the tube. In an embodiment, the polymer layers can be multilayered.

A further embodiment of the present disclosure provides a laminated tube comprising: multiple outer polyethylene layers having a thickness of 100 μ along with a pigment; multiple core aluminum layers having thickness in the range of 12 μ-20 μ between two acid copolymers; and multiple inner polyethylene layers having a thickness of 100 μ; wherein each of the two acid copolymer layers have thickness in the range of 20 μ-40 μ and the pigment is with a polyethylene resin in an amount in the range of 50% to 75% w/w ratio with the polyethylene carrier resin.

In still another embodiment of the present disclosure the laminated tube contains a hair colorant.

It is to be understood that when the barrier laminate in accordance with the present invention is made into a laminated tube, the tube is provided with suitable air tight closure with membrane seal. This closure of the tube orifice facilitates in keeping the contents of the tube in an air tight environment.

According to the disclosed embodiments, the barrier structure serves as an oxygen and moisture barrier for preventing the oxygen and moisture from entering the tube and destroying the hair color. Furthermore, it serves as a chemical resistance to prevent the ammonia from reacting with the Aluminum barrier layer.

In accordance with the present disclosure, the polyethylene layers on the two sides of the Aluminum barrier layer may be identical. In another embodiment, the polymers used for the outer side of the laminate and the inner side of the laminate, are of same type, having different thickness ratios. In yet another embodiment, the polyethylene used for both sides can be of different type having different thickness and density.

Although the subject matter has been described in considerable detail with reference to certain preferred embodiments thereof, other embodiments are possible. As such, the spirit and scope of the invention should not be limited to the description of the preferred embodiment contained therein.

### EXAMPLES

The disclosure will now be illustrated with working examples, which is intended to illustrate the working of the invention and not intended to take restrictively to imply any limitations on the scope of the present invention. Other embodiments are also possible. The inner barrier liner of the present disclosure is used in the tube shoulder that provides good barrier to both chemical and oxygen or humidity. The process of making the tube shoulder is discussed in the example below:

A barrier structure comprising an outer polyethylene layer containing a pigment; a core aluminum layer between two acid copolymer layers; and an inner polyethylene layer; wherein the pigment is with a polyethylene resin in an amount in the range of 50% to 75% w/w ratio with the polyethylene carrier resin was punched into the size and shape of the tube shoulder to be prepared to obtain a punched laminate. The punched laminate was then mounted on to a mandrel tip where the tube body was already pre-loaded. This resulted in a mandrel mounted with tube body which was then moved along with the barrier structure to a next station where a doughnut shaped High Density Polyethylene (HDPE) was dosed inside a shoulder mould. The shoulder mould, barrier structure and the mandrel mounted with the tube body was then closed and compressed to form the desired shape of the shoulder. The barrier structure was then fixed permanently to an inner dome surface of the compression molded tube shoulder. The tube shoulder was finally obtained by fusing the barrier structure medium density polyethylene layer with the melted doughnut shaped HDPE, thereby forming a permanent bond together with the composite linear barrier structure.

The previously described versions of the subject matter and its equivalent thereof have many advantages, including those which are described below:

1. The invention provides laminate tubes of thickness of as high as 290 μ that has improved barrier properties.
2. The invention enhances the quality of the products stored in the laminate tubes.
3. The invention also enhances shelf life of the products stored in the laminate tubes by preventing contamination with oxygen in air.

Although the subject matter has been described in considerable detail with reference to certain preferred embodiments thereof, other embodiments are possible. As such, the spirit and scope of the invention should not be limited to the description of the preferred embodiment contained therein.

We claim:

1. A barrier structure comprising :
an outer polyethylene layer containing a pigment;
a core aluminum layer between two acid copolymer layers; and
an inner polyethylene layer;
wherein the pigment is with a polyethylene resin in an amount in the range of 50% to 75% w/w ratio with the polyethylene carrier resin.

2. The barrier structure as claimed in claim 1, wherein the outer and inner polyethylene layer have density in the range of 0.94 g/cc to 0.96 g/cc.

3. The barrier structure as claimed in claim 1, wherein the acid copolymer is selected from ethylene acrylic acid copolymer (EAA), ethylene vinyl acetates, ethylene methacrylic acid copolymer, maleic anhydride copolymer, or mixtures thereof

4. The barrier structure as claimed in claim 3, wherein the acid copolymer is ethylene acrylic acid copolymer (EAA).

5. The barrier structure as claimed in claim 1, wherein the pigment in the outer polyethylene layer is a white pigment.

6. The barrier structure as claimed in 5, wherein the white pigment is selected from titanium dioxide (TiO₂), zinc disulfide (ZnS₂), zinc oxide (ZnO) and barium sulfate (BaSO₄).

7. The barrier structure as claimed in claim 6, wherein the white pigment is titanium oxide.

8. The barrier structure as claimed in claim 7, wherein the titanium oxide is with a polyethylene carrier resin in an amount in the range 50% to 75% w/w ratio with the polyethylene resin.

9. The barrier structure as claimed in claim 1, wherein the inner polyethylene layer is a multilayer film.

10. The barrier structure as claimed in claim 1, wherein said barrier structure is an internal barrier liner comprising:
an outer polyethylene layer having thickness in the range of 40 μ to 70 μ along with a pigment;
a core aluminum layer having thickness in the range of 12 μ to 20 μ between two acid copolymers layers; and
an inner polyethylene layer having thickness in the range of 40 μ to 70 μ;
wherein each of the two acid copolymers have a thickness in the range of 20 μ to 30 μ and the pigment is with a polyethylene resin in an amount in the range of 50% to 75% w/w ratio with the polyethylene carrier resin.

11. The barrier structure as claimed in claim 10, wherein said barrier structure is an internal barrier liner comprising:
an outer polyethylene layer having a thickness of 40 μ along with a pigment;
a core aluminum layer having a thickness of 20 μ between two acid copolymers layers; and
an inner polyethylene layer having a thickness of 50 μ;
wherein each of the two acid copolymers have a thickness in the range of 20 μ to 30 μ and the pigment is with a polyethylene resin in an amount in the range of 50% to 75% w/w ratio with the polyethylene carrier resin.

12. The barrier structure as claimed in claim 11, wherein the internal barrier liner has a total thickness in the range of 150 μ to 170 μ, preferably 160 μ.

13. The barrier structure as claimed in claim 10, wherein the pigment in the outer polyethylene layer of the internal barrier liner is a white pigment.

14. The barrier structure as claimed in claim 13, for manufacturing a tube shoulder, wherein said tube shoulder is made of high density polyethylene (HDPE).

15. The barrier structure as claimed in claim 14, wherein the tube shoulder is made by a process comprising:
punching a barrier laminate to the size and shape of the tube shoulder to be prepared to obtain a punched laminate;
mounting the punched laminate to a mandrel tip where the tube body is already pre-loaded to obtain a mandrel mounted with tube body;
moving the mandrel mounted with tube body and the barrier laminate to a next station where a doughnut shaped HDPE is dosed inside a shoulder mould;
closing and compressing the shoulder mould and the mandrel, mounted with tube body and barrier laminate to form a desired shape of a shoulder;
fixing the barrier laminate permanently to an inner dome surface of the compression molded tube shoulder; and
fusing the barrier laminate medium density polyethylene layer with the melted doughnut shaped HDPE, thereby forming a permanent bond together with the composite linear laminate to obtain the tube shoulder.

16. The barrier structure as claimed in claim 1, wherein said barrier structure is a laminate comprising :
an outer polyethylene layer having a thickness of 100 μ along with a pigment;
a core aluminum layer having thickness in the range of 12 μ-20 μ between two acid copolymers; and
an inner polyethylene layer having a thickness of 100 μ;
wherein each of the two acid copolymer layers have thickness in the range of 20 μ-40 μ and the pigment is with a polyethylene resin in an amount in the range of 50% to 75% w/w ratio with the polyethylene carrier resin.

17. The barrier structure as claimed in claim 16, wherein the core aluminum layer has a thickness of 20 μ.

18. The barrier structure as claimed in claim 16, wherein the laminate has a total thickness in the range of 250 μ-300 μ, preferably 290 μ.

19. The barrier structure as claimed in claim 16, where in the pigment in the outer polyethylene layer is a white pigment.

20. The barrier structure as claimed in claim 19, wherein the white pigment is titanium oxide.

21. The barrier structure as claimed in claim 16, wherein the layers of the laminate are multi-layered.

22. A laminated tube comprising:
outer polyethylene layers having a thickness of 100 μ along with a pigment;
a core aluminum layers having thickness in the range of 12 μ-20 μ between two acid copolymers; and
inner polyethylene layers having a thickness of 100 μ;
wherein each of the two acid copolymer layers have thickness in the range of 20 μ-40 μ and the pigment is with a polyethylene resin in an amount in the range of 50% to 75% w/w ratio with the polyethylene carrier resin.

23. The laminated tube as claimed in claim 22, wherein said laminated tube contains a hair colorant.
